(19) United States
(12) Patent Application Publication
(10) Pub. No.: US 2007/0251775 A1
(43) Pub. Date: Nov. 1, 2007

(54) Selective engagement apparatus and method

(76) Inventor: John F. Hehl SR., Delevan, NY (US)

Correspondence Address: CANTOR COLBURN, LLP, 55 GRIFFIN ROAD SOUTH, BLOOMFIELD, CT, 06002, US

(21) Appl. No.: 11/415,263

(22) Filed: May 1, 2006

(51) Int. Cl. B60L 7/00

(52) U.S. Cl. 188/171; 188/161

(57) ABSTRACT

A selective braking or clutching device includes a housing, an armature partially received within the housing and defining a radial air gap between the armature and the housing, and a coil productive of a magnetic field, a flux thereof being radially directed through the air gap. A method for extending the life of a selective braking or clutching device including positioning an armature relative to a housing such that a radial air gap is created between the housing and armature causing a magnetic flux to pass through the air gap in a radial direction.

### BACKGROUND

Devices used for braking or clutching are common in industry. It is often desirable to selectively control speed of a rotatable component of a device or to selectively engage a rotatable component. Such devices are utilized in industry for many and varied applications including actuators in assembly lines, automated systems, etc.

Currently, braking and clutching duties are handled by devices including magnetorheological fluid based devices and spring-based devices. While commercially available devices generally operate as marketed and are effective for some applications, they are expensive, lack adjustability, or both.

Since greater economy and adjustability are always desirable, improvements are always well received.

### SUMMARY OF THE INVENTION

A selective braking or clutching device includes a housing, an armature partially received within the housing and defining a radial air gap between the armature and the housing, and a coil productive of a magnetic field, a flux thereof being radially directed through the air gap.

A method for extending the life of a selective braking or clutching device including positioning an armature relative to a housing such that a radial air gap is created between the housing and armature causing a magnetic flux to pass through the air gap in a radial direction.

A selective braking or clutching device including a housing, a shaft supported at the housing, at least one friction disk disposed in driving communication with the shaft, a plurality of thrust washers alternatingly disposed with the friction disk, an armature in operable communication with the thrust washers and partially received within the housing and positioned therein to create a radial air gap, and a coil at the housing capable of generating a magnetic field.

### BRIEF DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a cross section view of a selective engagement device;

FIG. 1a is a plan view of the device illustrating the section line for FIG. 1;

FIG. 2 is a perspective view of a shaft of the device;

FIG. 3 is a perspective view of an armature of the device;

FIG. 4 is a perspective view of a housing of the device;

FIG. 5 is a plan view of a thrust washer of the device;

FIG. 6 is a plan view of a friction disk of the device; and

FIG. 7 is an enlarged view of circumscribed area 7-7 in FIG. 1.

### DETAILED DESCRIPTION OF THE DRAWINGS

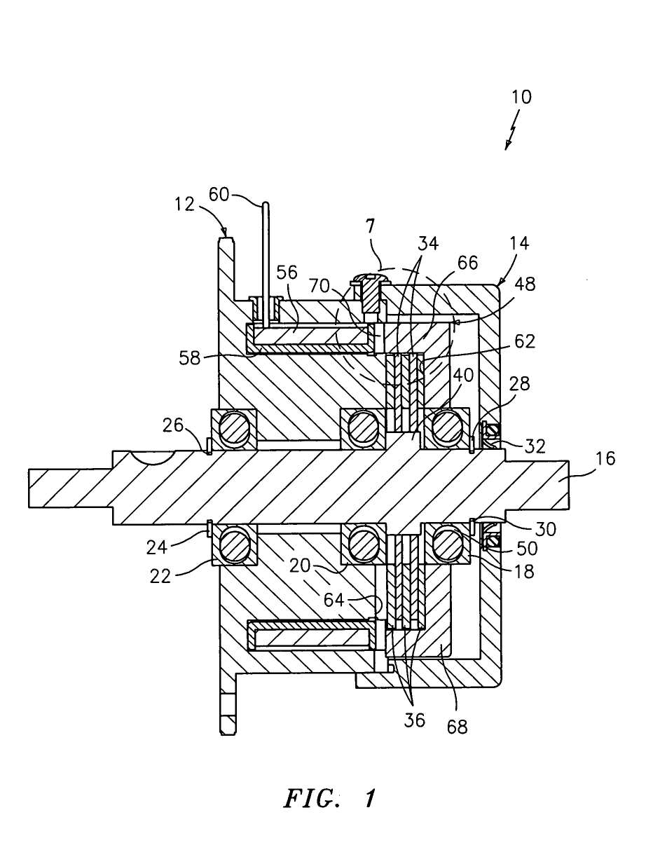

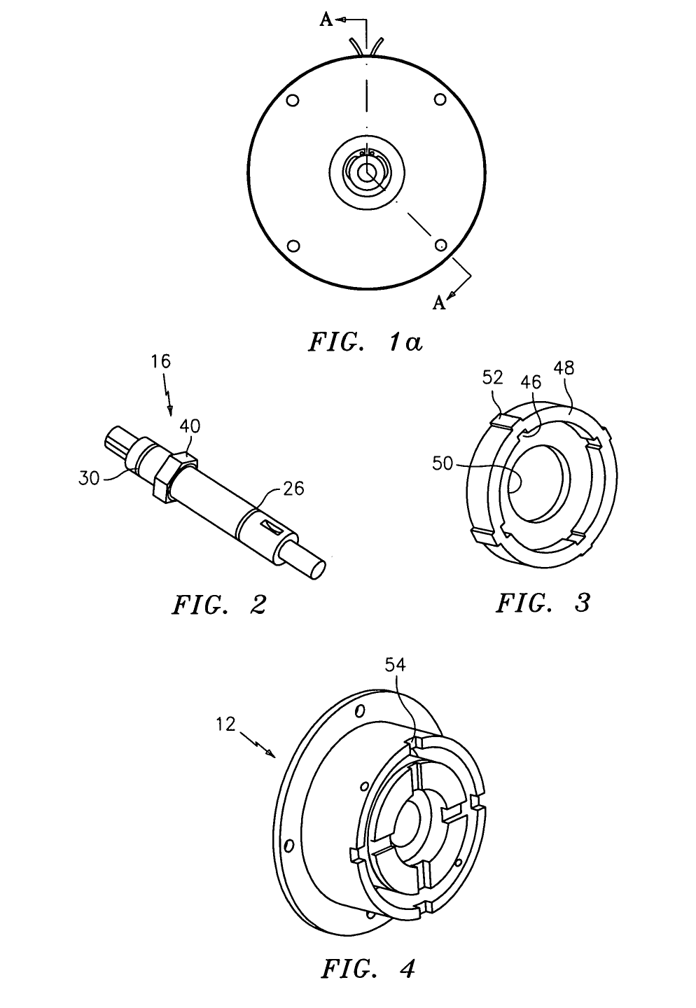

Referring to FIG. 1, a selective engagement device 10 is generally depicted in cross section. It is important to note that the section line as depicted is not a diametral line but rather is that illustrated in FIG. 1a. The device includes a coil housing 12 and cover 14. Supported within the coil housing 12 and cover 14 are a rotary shaft 16 supported by bearings 18, 20 and 22. A retention ring 24 is positionable in a groove 26 adjacent to bearing 22 while retention ring 28 is positioned in groove 30 adjacent bearing 18 to retain the shaft 16 in its desired position relative to the housing 12 and cover 14. Further provided is a seal 32 to maintain the environment internal to housing 12 and cover 14.

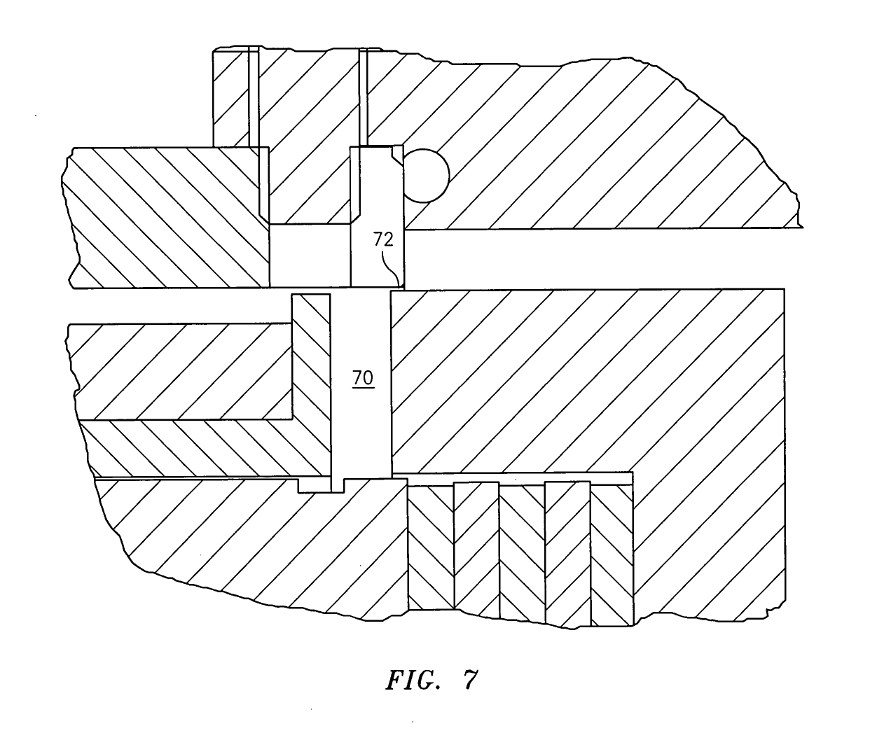

A plurality of friction disks 34 is positioned, in alternating manner, with a plurality of thrust washers 36. In the illustrated embodiment, there are shown two friction disks and three thrust washers. It will be understood however that the number of disks and thrust washers is not limited to that shown but that more or fewer could be utilized in particular applications, even including none. If none is desired, then in one embodiment the housing surface facing the armature and the armature surface opposing the identified housing surface will be hardened or otherwise treated to prolong wear resistance. Returning to the illustrated embodiment, the friction disks 34 are driven by (or drive through) shaft 16 in one embodiment through the use of a hexagonal opening 38 (see FIG. 6) complimentary to a hexagonal drive profile 40 (see FIG. 2) on shaft 16. It is to be appreciated that while a hexagonal drive shape has been employed in the embodiment illustrated, any geometric shape having sufficient drive capability for the application is substitutable for the hexagonal shape. This includes a splined connection, should one be desirable. Functionality is provided by the disks being driven at the axis thereof as will become more apparent hereinafter. The plurality of thrust washers 36, on the other hand are configured to clear drive profile 40 with an opening 42 that is simply large enough to not engage whatever geometric profile is utilized for profile 40 (see FIG. 4), the point in this instance being that the thrust washers are to be rotatable relative to the shaft and friction disks or the shaft (and frictions disks) be rotatable relative to the washers. The thrust washers 36 include engagement tabs 44, which in one embodiment number four evenly spaced around each thrust washer 36. Tabs 44 are intended to be engaged by at least one recess 46 in armature 48 (see FIG. 3, four shown). The tabs engaged with recesses 46 prevent relative rotational motion between the washers and the armature.

Armature 48 includes a bearing opening 50 in which bearing 18 is received to support armature 48. Armature 48 is axially displaceable along bearing 18 such that it may be actuated against the thrust washers and friction disks when it is desired to slow or stop relative rotation between shaft 16 and the housing and cover 12, 14. In one embodiment, it is necessary that the armature not have relative rotational motion capability with respect to the housing 12. Thus, as illustrated in FIG. 3, armature 48 is provided with engagement risers 52. Four risers 52 are illustrated although more or fewer could be used. In the illustrated embodiment, using four risers 52 and four recesses 46 maintains annular thickness of the armature 48.

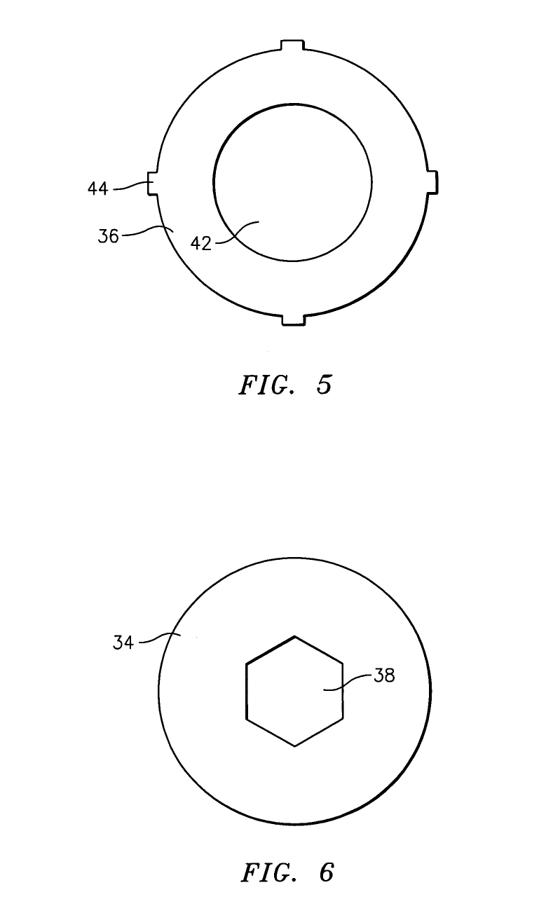

Referring to FIGS. 5 and 6, the disks 34 and washers 36 are illustrated apart from other structures. The washer tabs 44 as noted are intended to engage in recesses 46 for a non-rotational engagement with armature 48. To complete the nonrotational engagement from the washers 36 to housing 12, the risers 52 engage grooves 54 (illustrated in FIG. 4). With this arrangement, the washers 36 are substantially rotationally immobile relative to the housing 12, which facilitates the purpose of the device.

With the washers 36 immobile and the friction disks 34 sandwiched between the washers 36 (and configured to rotate with the shaft 16) the friction disks must slide past the washers 36. Because of this arrangement, if a compressive load is applied to the washers/disks, the effective total friction rises and relative motion between the washers and disks stops. Such inhibition of relative motion may be used for braking or clutching in various applications. The impetus for the compressive load in the depicted embodiment is an electromagnetic attractive force generated between the housing 12 and the armature 48. It is noted here that a specific relationship for the armature and housing is disclosed herein and will be detailed hereunder. A coil 56, as illustrated in FIG. 1, generates the electromagnetic force. The coil 56 is cradled in a bobbin 58 disposed within housing 12. One lead 60 (of two, the other not being visible in this view), electrically connected to the coil 56 is illustrated in FIG. 1 for clarity.

Coil 56 becomes magnetically active when a voltage is applied thereto. The magnetic properties of coil 56 are utilized to draw armature 48 towards the coil 56 thereby compressing thrust washers 36 and friction disks 34 between an inside surface 62 of armature 48 and a housing surface 64. Compression of washers 36 and disks 34 creates significant friction to be utilized in retarding relative rotation between shaft 16 and housing 12, as noted above. The device disclosed herein provides for a significantly longer life than prior art devices as it is capable of about forty-thousandths of an inch of wear in the friction generating members before losing selective braking or clutching power whereas the prior art is merely capable of ten thousandths of an inch of wear. The invention accomplishes this desirable result by causing the magnetic flux path of the device to flow radially rather than axially through the air gap between the housing and armature. This is contrary to what clutching and braking devices have done in the past. The creation of the radial flux path is occasioned by the addition to the armature 48 of a ring of material 66 positioned to extend from a planar portion 68 of armature 48 into an annular space 70 within which bobbin 58 and coil 56 are disposed. The ring 64, because it extends into the space 70 by a small amount, while providing a radial air gap 72 between the hosing 12 and the armature 48, physically causes the flux path to flow radially as opposed to axially, as it does in the prior art. The arrangement provides for a lower total magnetic force on the armature but one that is consistent over a longer range. This is what provides the benefit of the greater wear tolerance in the present arrangement. It is further noted that the air gap 72 between the housing 12 and the armature 48, because it is radially configured, does not change in radial dimension regardless of the wear in the friction disks 34. Prevention of change in the dimension of the air gap through which the flux passes contributes to the steady field generated over the life of the device. Referring to FIG. 7, an enlarged view of a portion of FIG. 1 allows for illustration of the air gap 72.

The device as detailed hereinabove provides not only for greater wear tolerance in use but also allows for selectivity in the amount of braking force or clutching engagement it will impart to a particular system. This benefit is occasioned by the fact that the device is ultimately controlled by the amount of voltage put to the coil 56. The greater the voltage applied to the coil, the greater the magnetic field generated thereby. The greater the magnetic field the stronger the pull on the armature, and consequently the greater the compression of the friction disks. The amount of friction generated between the thrust washers and friction disks therefore can be varied as a function of the applied voltage.

It is noted that the above-described embodiment is one possible embodiment utilizing the radial air gap and flux path disclosed. It should also be appreciated however that the essential features of this concept, i.e. braking or clutching can also be carried out using the radial air gap and flux path but without utilizing friction disks or thrust washers. In such embodiment, the armature would be rotatable relative to the housing when the coil was not energized and would be pulled into frictional contact with the housing when the coil is energized. This would promote wear of the housing and the armature but with suitable selection of materials, the device would work acceptably.

In accordance with the provisions of the patent statutes, the present invention has been described in what is considered to represent its preferred embodiment. However, it should be noted that the invention can be practiced otherwise than as specifically illustrated and described.

What is claimed is:

1. A selective braking or clutching device comprising:
a housing;
an armature partially received within the housing and defining a radial air gap between the armature and the housing;
a coil productive of a magnetic field, a flux thereof being radially directed through the air gap.

2. A selective braking or clutching device as claimed in claim 1 wherein the armature includes a planar portion and a ring portion extending axially therefrom.

3. A selective braking or clutching device as claimed in claim 1 wherein the air gap is of a substantially fixed, radial dimension over a life of the device.

4. A selective braking or clutching device as claimed in claim 1 wherein the device includes at least one friction disk disposed between the housing and the armature.

5. A selective braking or clutching device as claimed in claim 4 wherein the friction disk is subjectable to an axial compressive load.

6. A selective braking or clutching device as claimed in claim 4 wherein the friction disk is rotationally fixed to a shaft supported at the housing.

7. A selective braking or clutching device as claimed in claim 6 wherein the disk is rotationally fixed to the shaft by a geometrically shaped opening therein complementary to a geometrically shaped portion of the shaft.

8. A selective braking or clutching device as claimed in claim 4 wherein the device further includes a plurality of thrust washers alternately positioned relative to the friction disk.

9. A selective braking or clutching device as claimed in claim 8 wherein the plurality of thrust washers include at least one tab each engagable with the armature to inhibit relative rotation between the plurality of washers and the armature.

10. A method for extending the life of a selective braking or clutching device comprising:
positioning an armature relative to a housing such that a radial air gap is created between the housing and armature causing a magnetic flux to pass through the air gap in a radial direction.

11. A method for extending the life of a selective braking or clutching device as claimed in claim 10 wherein the method further includes activating a magnetic field by applying a voltage to a coil in operable communication with the housing.

12. A selective braking or clutching device comprising:
a housing;
a shaft supported at the housing;
at least one friction disk disposed in driving communication with the shaft;
a plurality of thrust washers alternatingly disposed with the friction disk;
an armature in operable communication with the thrust washers and partially received within the housing and positioned therein to create a radial air gap;
a coil at the housing capable of generating a magnetic field.
